(19) United States
(12) Patent Application Publication
(10) Pub. No.: US 2025/0358921 A1
(43) Pub. Date: Nov. 20, 2025

(54) CHRISTMAS DECORATION DEVICE WITH OPTICAL FIBERS AND CIRCUIT CONTROL METHOD

(71) Applicant: KING TREE HANDICRAFTS (SHENZHEN)CO., LTD., Shenzhen (CN)

(72) Inventor: XIAOPENG HAO, Tianjin (CN)

(21) Appl. No.: 18/663,444

(22) Filed: May 14, 2024

(51) Int. Cl. H05B 47/19; F21S 4/10; F21V 8/00; F21V 19/00; F21Y 113/00; F21Y 115/10; H05B 45/20

(52) U.S. Cl. CPC H05B 47/19; F21S 4/10; F21V 19/0035; F21V 19/004; G02B 6/0008; H05B 45/20; F21Y 2113/00; F21Y 2115/10

(57) ABSTRACT

A Christmas decoration device with optical fibers and a circuit control method are provided, the Christmas decoration device includes a controller, which is connected with a plurality of light-emitting components in series. The light-emitting components include light-emitting parts connecting with the controller in series, each light-emitting part is connected to an optical fiber part. The optical fiber part transmits light emitted by the light-emitting parts. The controller includes a control circuit, the light-emitting parts realize color switching under a control of the control circuit. A color switching function of the light-emitting parts is achieved through a design of the control circuit. A user can choose different color combinations according to needs, which adds more colors and changes to decoration, and creates a stronger festive atmosphere; the optical fiber part is used as a medium for transmitting light, and the light can be dispersed and spread to various corners.

### TECHNICAL FIELD

The present disclosure relates to the field of decorative lights technologies, and in particular, to a Christmas decoration device with optical fibers and a circuit control method.

### BACKGROUND

Christmas decorative light, as a common decorative item during holidays, can be traced back to the ancient era of candle lighting. At that time, candles are used by people to light Christmas trees, which symbolizes starlight on the tree and brings warmth and mystery to the holiday. However, candle lighting has safety hazards and is prone to fire accidents, so the use is limited. With the advancement of technology, especially an emergence of a LED (Light Emitting Diode) light technology, modern Christmas decorative lights have been greatly improved. LED decorative light is not only safer and more reliable, but also has advantages such as energy conservation, environmental protection, and long service life. Therefore, it is widely used in Christmas decoration.

Traditional Christmas decorative lights usually use a single LED string, with fixed and monotonous colors, which is difficult to meet people's diverse needs for festive atmosphere. In addition, traditional decorative lights have limited light transmission ways and cannot create more unique and creative visual effects. Therefore, a Christmas decoration device with optical fibers and a circuit control method are provided.

### SUMMARY

The purpose of the present disclosure is to address the current background technology that traditional decorative lights usually use a single LED string, with fixed and monotonous colors, which is difficult to meet people's diverse needs for holiday atmosphere. In addition, traditional decorative lights have limited light transmission ways and cannot create more unique and creative visual effects.

In order to achieve the above-mentioned objectives, the present disclosure provides a Christmas decoration device and a circuit control method to improve the above-mentioned problems.

The present application is as follows.

A Christmas decoration device with optical fibers, including a controller, where the controller is connected with a plurality of light-emitting components in series, where the controller is connected with a plurality of light-emitting components in series, the light-emitting components include light-emitting parts that are connected with the controller in series, each light-emitting part is connected to an optical fiber part, the optical fiber part is configured to transmit light emitted by the light-emitting parts, the controller includes a control circuit, and the light-emitting parts realize color switching under a control of the control circuit.

In an embodiment of the present application, the control circuit includes a first circuit interface port and a second circuit interface port, the first circuit interface port is connected to a diode D1, a resistor R1, and a third circuit interface port; the diode D1 is connected to the second circuit interface port, the resistor R1 is connected to a voltage stabilizing diode Z1 and a capacitor C1, both the capacitor C1 and the voltage stabilizing diode Z1 are connected to the second circuit interface port; a first grounding terminal GND1 is connected between the second circuit interface port, diode D1, and capacitor C1;
the control circuit further includes a main control chip U1, a radio frequency chip U2, a radio frequency chip RF, the capacitor C1, the resistor R1, and the voltage stabilizing diode Z1; where a first pin of the main control chip U1, a first pin of the radio frequency chip U2 and a first pin of the radio frequency chip RF are connected;
a second pin of the main control chip U1 is connected to a fourth circuit interface port, an eighth pin of the main control chip U1 is connected to a button switch S1, the eighth pin of the main control chip U1 is further connected to the capacitor C1, the voltage stabilizing diode Z1, and the first grounding terminal GND1; the other end of the button switch S1 is connected to a fifth pin of the radio frequency chip U2.

In an embodiment of the present application, the diode D1 is further connected to a second grounding terminal GND2, the second grounding terminal GND2 is connected to a third grounding terminal GND3, and the third grounding terminal GND3 is connected to a fifth circuit interface port, a third pin of the radio frequency chip RF and a fourth pin of the radio frequency chip RF are both connected to the third grounding terminal GND3;

a seventh pin of the main control chip U1 is connected to a sixth pin of the radio frequency chip U2, the sixth pin of the main control chip U1 is connected to a seventh pin of the radio frequency chip U2, the eighth pin of the radio frequency chip U2 is connected to a fourth grounding terminal GND4, a third pin of the radio frequency chip U2 and a second pin of the radio frequency chip U2 are respectively connected with a capacitor C3 and a capacitor C2, both capacitor C3 and capacitor C2 are connected to the third grounding terminal GND3 and the fifth circuit interface port; a crystal oscillator circuit Y1 is connected in parallel between the third pin of the radio frequency chip U2 and the second pin of the radio frequency chip U2.

In an embodiment of the present application, the control circuit is further connected to a remote control, which is provided with a control motherboard, a communication module and a plurality of control buttons are connected to the control motherboard.

In an embodiment of the present application, light-emitting parts includes a lamp housing, an end of the lamp housing is connected to a first LED light, and the first LED light is connected to the control circuit; an outer surface of the lamp housing is sleeved with a connection tube, a retaining ring is fixedly provided in the connection tube, and the retaining ring is in contact with the first LED light.

In an embodiment of the present application, the outer surface of the lamp housing is fixedly connected with a plurality of first protrusions, an inner wall of the connection tube is fixedly connected with a plurality of second protrusions; the second protrusions and the first protrusions are interlocked so as to limit the lamp housing.

In an embodiment of the present application, the optical fiber part is a first optical fiber bundle, which is consisted of a plurality of optical fibers, an end of the first optical fiber bundle is connected to the connection tube in an insertion manner.

In an embodiment of the present application, the light-emitting parts include a lamp cup, where a lamp plate is provided in the lamp cup, and a plurality of second LED lights are provided on the lamp plate, the second LED lights are connected to the control circuit.

In an embodiment of the present application, the optical fiber part is a second optical fiber bundle, which is consisted of a plurality of optical fibers, and the second optical fiber bundle is provided on the second LED light.

A circuit control method for controlling the Christmas decoration device with optical fibers, including:
a first circuit interface port and a second circuit interface port being configured to be an input terminal, connect to an external power supply or a signal source, the first circuit interface port is configured to provide a main power supply input and conduct preliminary rectification and current limiting through a diode D1 and a resistor R1 to obtain voltage supply for the circuit; a filtering and voltage regulator circuit is formed by a capacitor C1, a resistor R1, and a voltage stabilizing diode Z1 together so as to perform a smooth processing on power supply and voltage;
color and mode of a LED light is manually controlled through a button switch S1 by a user after the circuit is powered on normally, when the button switch S1 or a control button of a remote control is pressed by the user, electrical signal is transmitted to a main control chip U1, the signal is analyzed by the main control chip U1 according to a preset program logic and a corresponding control instruction is generated; then the control instruction is transmitted to a drive circuit of the LED light through an output pin of the main control chip U1; a third circuit interface port is configured to be as one of output terminals, connect the drive circuit of LED light and transmit a control signal; driving current, frequency, and direction of the LED light are adjusted by the drive circuit of LED light according to the instruction after receiving it so as to change the color and mode of the LED light;
a radio frequency chip U2 and a radio frequency chip RF, configured to receive signal from the remote control or other wireless devices; the signal is decoded by the radio frequency chip U2 and radio frequency chip RF and transmitted to the main control chip U1 when a valid wireless signal is received; a corresponding control logic according to the instruction in the wireless signal is executed by the main control chip U1 and the control signal is sent to the LED light through the third circuit interface port;
power supply and external control signal are received through the first circuit interface port and second circuit interface port, processed by the main control chip U1 and radio frequency chip RF, the control instruction is outputted by the third circuit interfaces port, a fourth circuit interface port and a fifth circuit interface port so as to control the color and mode of the LED light.

Compared with existing technology, the beneficial effects of the present disclosure are:
in the technical solution of the present application:
through a design of the control circuit, this product achieves a function of switching color of the light-emitting parts. A user can choose different color combinations according to needs, which adds more colors and changes to decoration, and creates a stronger festive atmosphere; as the optical fiber component is configured to be as a medium for transmitting light, the light can be dispersed and spread to various corners, a unique light and shadow effect is generated. The user can adjust position and angle of the optical fiber part according to needs, thereby creating various decorative effects and increasing layering and three-dimensional sense of decoration.

### BRIEF DESCRIPTION OF DRAWINGS

FIG. 1 is a structural schematic diagram of a Christmas decoration device with optical fibers provided in the present application.

FIG. 2 is a structural schematic diagram of a top view of FIG. 1 provided in the present application.

FIG. 3 is a structural schematic diagram of a lamp housing provided in the present application.

FIG. 4 is an exploded view of FIG. 3 provided in the present application.

FIG. 5 is a schematic diagram of a cross-sectional structure of a connection tube provided in the present application.

FIG. 6 is a structural schematic diagram of the Christmas decoration device with optical fibers provided in the present application.

FIG. 7 is a structural schematic diagram of a top view of FIG. 6 provided in the present application.

FIG. 8 is a structural schematic diagram of a lamp cup provided in the present application.

FIG. 9 is a structural schematic diagram of a second optical fiber bundle provided in the present application.

FIG. 10 is a structural schematic diagram of a second LED light provided in the present application.

FIG. 11 is a circuit diagram of the Christmas decoration device with optical fibers provided in the present application.

Numeral reference: 1. 100. Controller; 200. Power supply plug; 301. Lamp housing; 302. First LED light; 303. Connection tube; 304. First optical fiber bundle; 305. First protrusion; 306. Second protrusion; 307. Retaining ring; 401. Lamp cup; 402. Second optical fiber bundle; 403. Second LED light; 404. Lamp plate; 500. Remote control.

### DESCRIPTION OF EMBODIMENTS

In order to facilitate a better understanding of the present disclosure by those skilled in the art, the following will provide a clear and complete description of the technical solutions in the embodiments of the present disclosure, in combination with the accompanying drawings. Obviously, the described embodiments are only a part of the embodiments of the present disclosure, not all of them. Based on the embodiments in the present disclosure, all other embodiments obtained by ordinary technicians in the art without creative work shall fall within the protection scope of the present disclosure.

In order to facilitate a better understanding of the present disclosure by those skilled in the art, a clear and complete description of the technical solution in the embodiments of the present disclosure will be provided below, in combination with the accompanying drawings.

It should be noted that, without conflict, the embodiments and the features and technical solutions in the embodiments of the present disclosure can be combined with each other.

It should be noted that similar labels and letters represent similar terms in the following drawings. Therefore, once a term is defined in one drawing, it does not need to be further defined or explained in subsequent drawings.

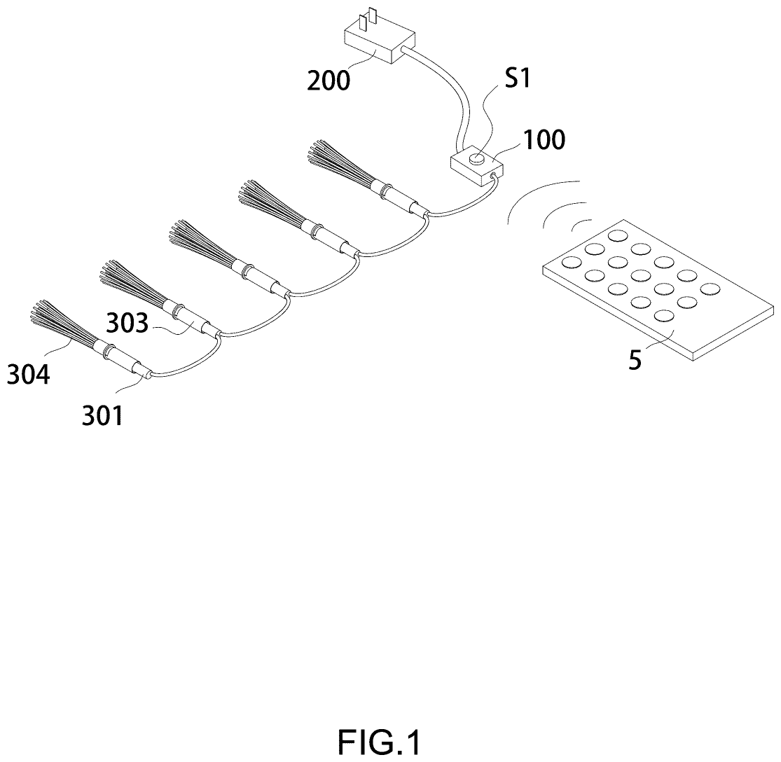

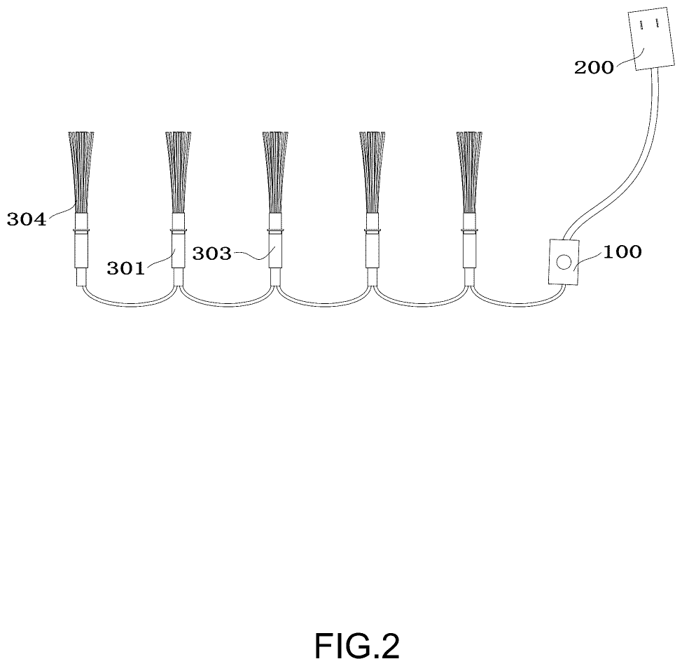

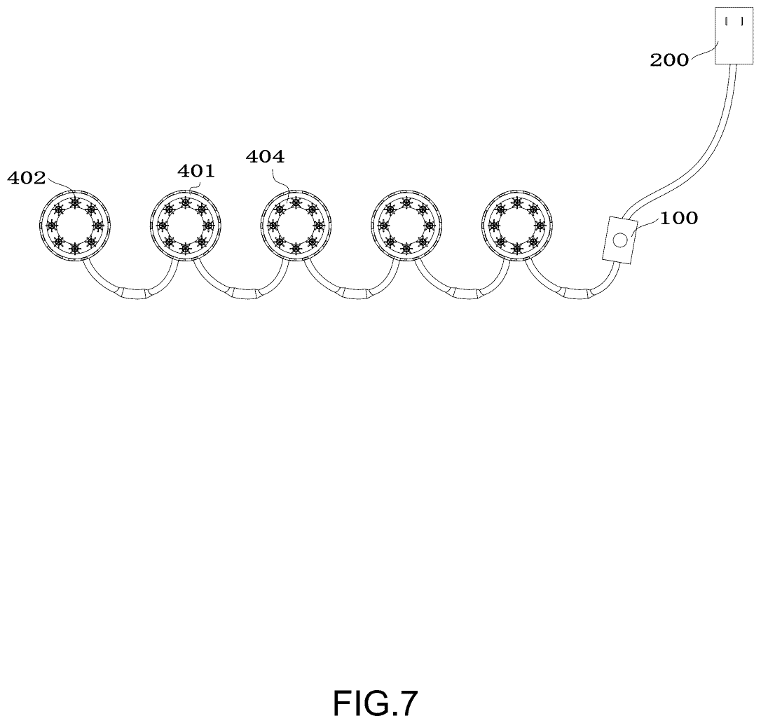

Embodiment 1, please refer to FIGS. 1, 2, 6, and 7. A Christmas decoration device with optical fibers, including a controller 100, which is connected with a plurality of light-emitting components in series. The light-emitting components include light-emitting parts that are connected with the controller 100 in series, each light-emitting part is connected to an optical fiber part. The optical fiber part is configured to transmit light emitted by the light-emitting part. The controller 100 includes a control circuit, and the light-emitting parts switch colors under a control of the control circuit. The controller 100 is further connected to a power plug 200; a unified control of the plurality of light-emitting components is achieved through the controller 100, each light-emitting component is provided with an optical fiber part to evenly distribute light and improve an overall decorative effect; thereby allowing a user to easily control the plurality of light-emitting components, the overall decoration effect can be unified and coordinated. An application of the optical fiber part in the present application renders the light distribution more uniform, enhances the layering and aesthetics of decoration, and provides a strong support for creating a festive atmosphere.

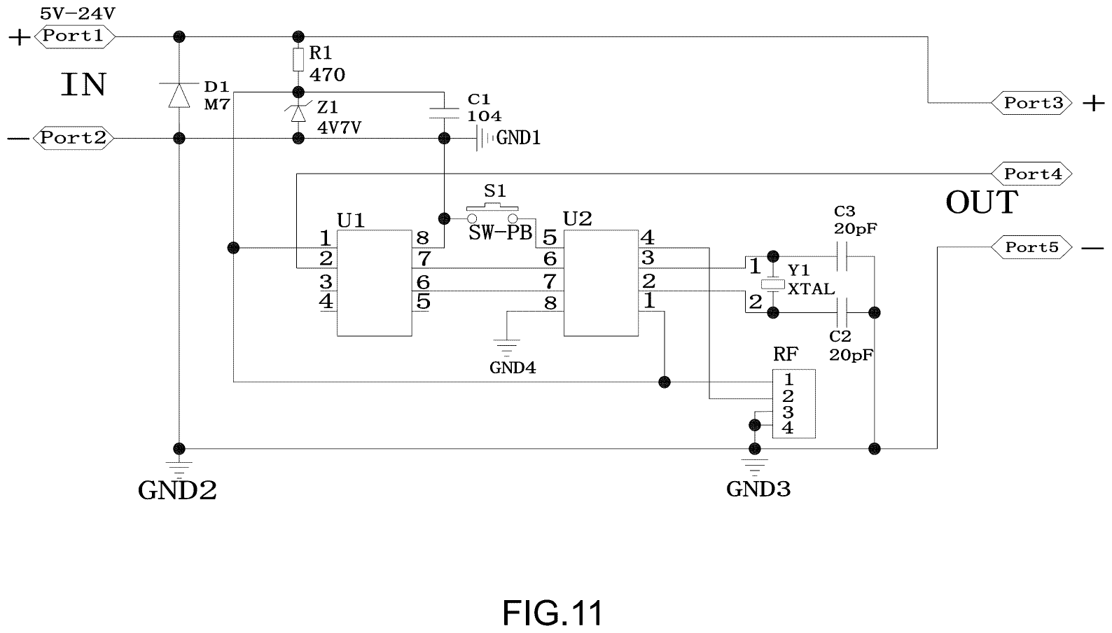

In an implementation, as shown in FIG. 11, the control circuit includes a first circuit interface port and a second circuit interface port. The first circuit interface port is connected to a diode D1, a resistor R1, and a third circuit interface port. The diode D1 is connected to the second circuit interface port, and the resistor R1 is connected to a voltage stabilizing diode Z1 and a capacitor C1. Both the capacitor C1 and the voltage stabilizing diode Z1 are connected to the second circuit interface port. A grounding terminal GND1 is connected between the second circuit interface port, diode D1, and capacitor C1.

The control circuit further includes a main control chip U1, a radio frequency chip U2, a radio frequency chip RF, a capacitor C1, a resistor R1, a voltage stabilizing diode Z1; a first pin of the main control chip U1, a first pin of the radio frequency chip U2, and a first pin of the radio frequency chip RF are connected. A design of the control circuit includes a collaborative work of the first circuit interface port, the second circuit interface port, the diode D1, the resistor R1, the capacitor C1, the voltage stabilizing diode Z1, and the main control chip U1, thereby ensuring a stability of power input and providing stable driving current for the LED light. Through the carefully designed control circuit, this embodiment effectively eliminates an impact of power fluctuations on LED performance, thereby ensuring a stable LED emission, and the collaborative work of circuit components improves an overall efficiency of the circuit, reduces energy consumption, and provides a user with energy-saving and environmentally friendly Christmas decoration device.

A second pin of the main control chip U1 is connected to a fourth circuit interface port, an eighth pin of the main control chip U1 is connected to a button switch S1. The eighth pin of the main control chip U1 is further connected to the capacitor C1, the voltage stabilizing diode Z1, and a first grounding terminal GND1. The other end of the button switch S1 is connected to a fifth pin of the radio frequency chip U2 and installed on an outer side of the controller 100 so that the user can press.

In an embodiment, as shown in FIG. 11, the diode D1 is further connected to a second grounding terminal GND2, the second grounding terminal GND2 is connected to a third grounding terminal GND3, the third grounding terminal GND3 is connected to a fifth circuit interface port. Both a third pin and a fourth pin of the radio frequency chip RF are connected to the third grounding terminal GND3.

A seventh pin of the main control chip U1 is connected to a sixth pin of the radio frequency chip U2. The sixth pin of the main control chip U1 is connected to a seventh pin of the radio frequency chip U2. The eighth pin of the radio frequency chip U2 is connected to a fourth grounding terminal GND4. The third pin of the radio frequency chip U2 and the second pin of the radio frequency chip U2 are respectively connected to the capacitor C3 and capacitor C2. Both capacitor C3 and capacitor C2 are connected to the third grounding terminal GND3 and a fifth circuit interface port. A crystal oscillator circuit Y1 is connected in parallel between the third pin of the radio frequency chip U2 and the second pin of the radio frequency chip U2.

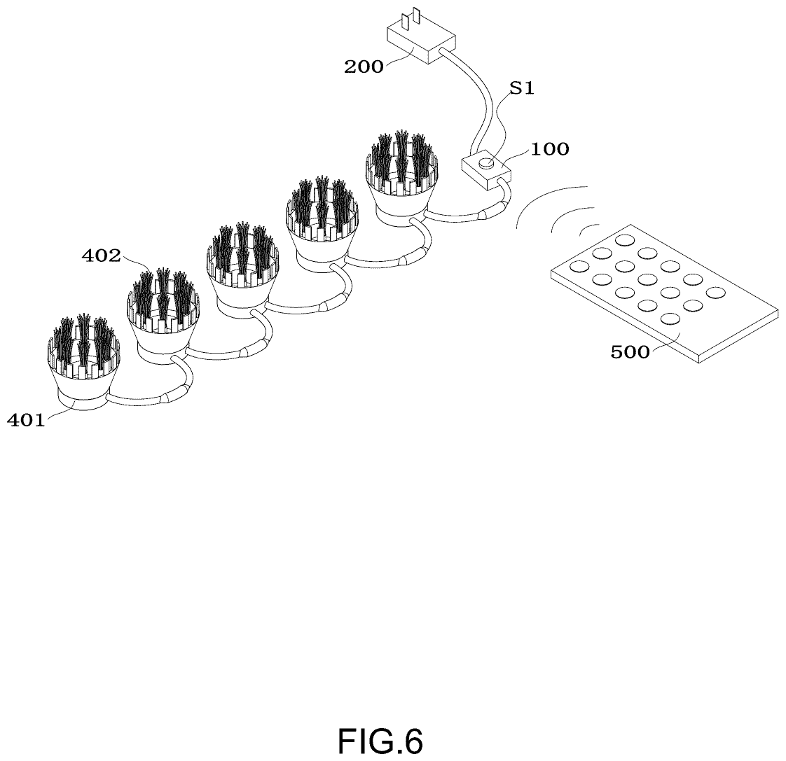

In an implementation, as shown in FIGS. 1 and 6, the control circuit is further connected to a remote control 500, which is provided with a control motherboard. The control motherboard is connected to a communication module and a plurality of control buttons; a setting of the remote control 500 allows the user to remotely control the Christmas decoration device without a need for manual operation of each light-emitting component, thereby greatly improving a convenience of use and enhancing the user experience.

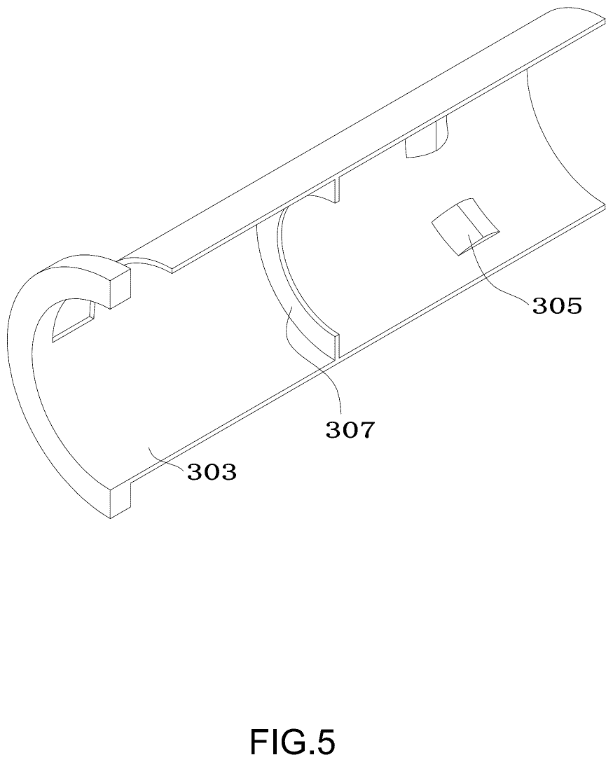

Embodiment 2 further optimizes the Christmas decoration device with optical fiber provided in Embodiment 1. Specifically, as shown in FIGS. 1 and 5, the light-emitting parts include a lamp housing 301, an end of which is connected to a first LED light 302, which is connected to the control circuit. An outer surface of the lamp housing 301 is sleeved with a connection tube 303, a retaining ring 307 is fixedly provided in the connection tube 303, and the retaining ring 307 is in contact with the first LED light 302.

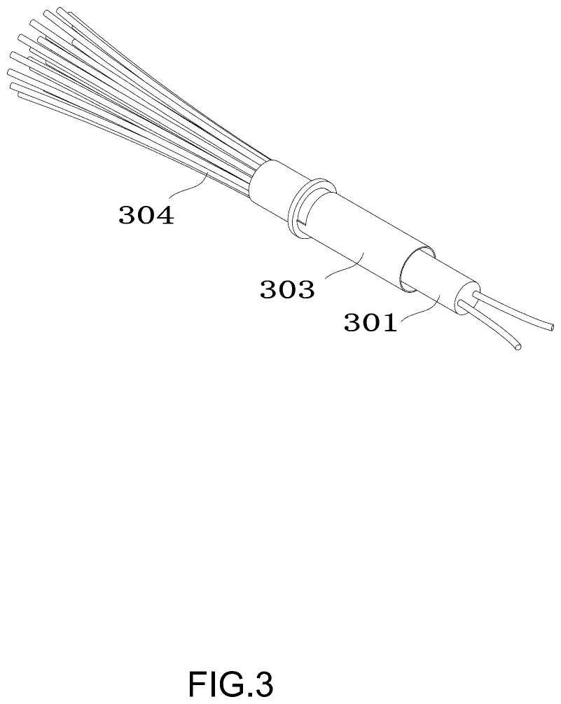

In an embodiment, as shown in FIGS. 3 to 5, an outer surface of the lamp housing 301 is fixedly connected with a plurality of first protrusions 305, an inner wall of the connection tube 303 is fixedly connected with a plurality of second protrusions 306. The second protrusion 306 and the first protrusion 305 are interlocked so as to limit the lamp housing 301, rendering the structure more compact and stable. The lamp housing 301 is pulled to separate the second protrusion 306 from the first protrusion 305 so that the lamp housing 301 can be separated from the connection tube 303, and the first LED light 302 can be maintenance and repaired.

In an embodiment, as shown in FIGS. 1 to 4, the optical fiber part is a first optical fiber bundle 304, which is consisted of a plurality of optical fibers. An end of the first optical fiber bundle 304 is connected to the connection tube 303 in an insertion manner, a setting of the first optical fiber bundle 304 improves brightness and uniformity of the decoration effect, rendering the decoration more beautiful and eye-catching. The first optical fiber bundle 304 being connected to the connection tube 303 in an insertion manner allows the first optical fiber bundle 304 can be repaired and provide the user with more choices.

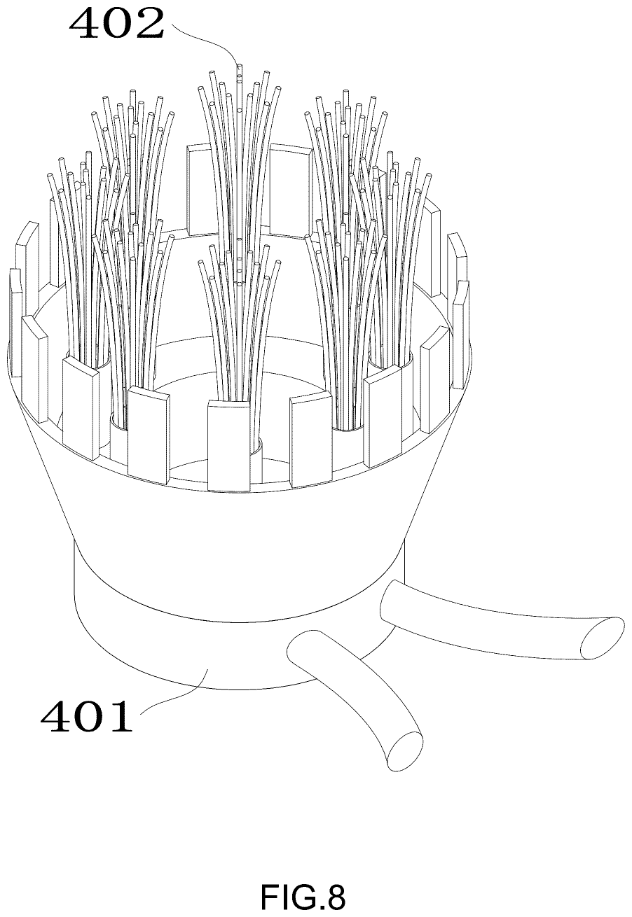

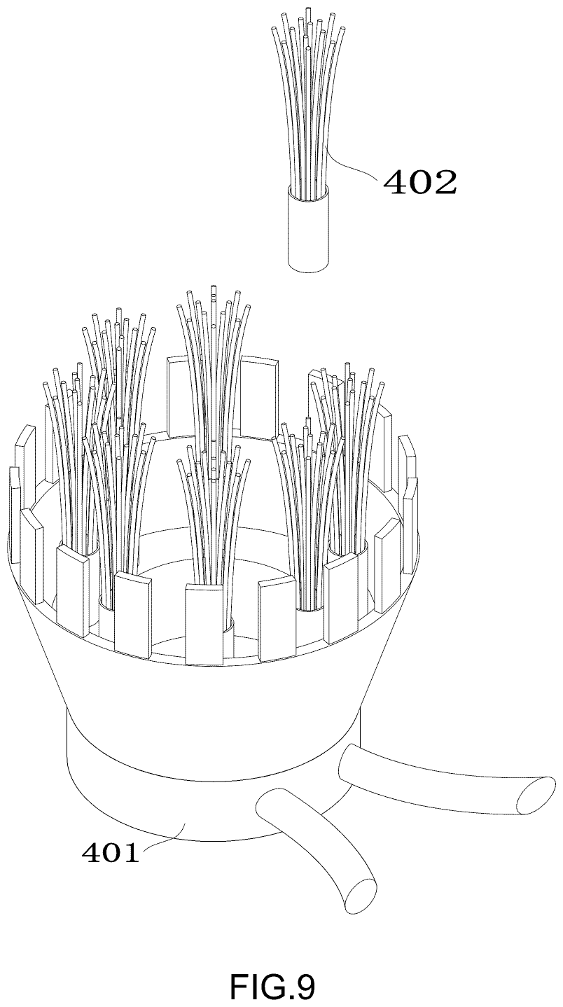

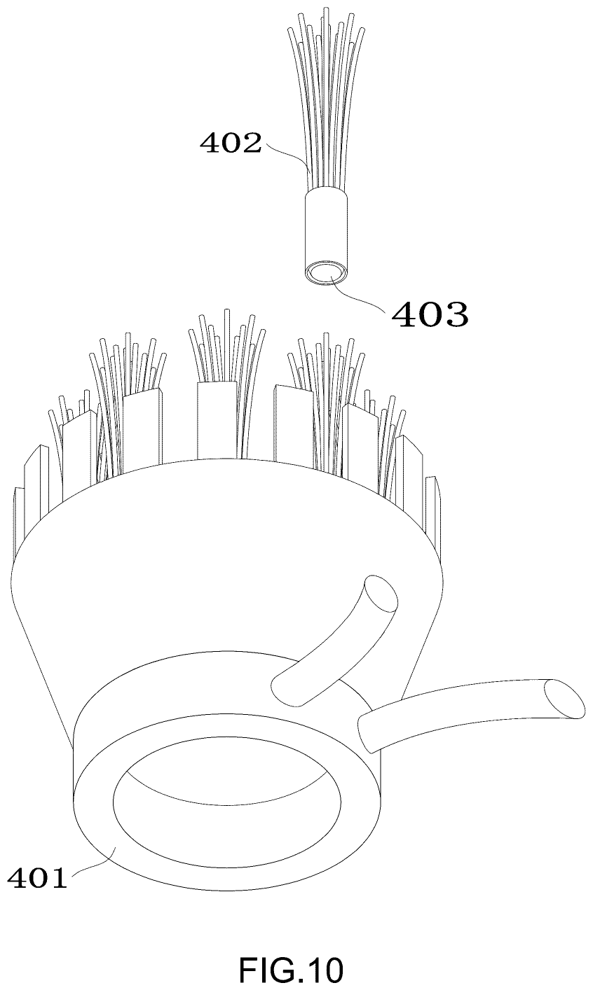

Embodiment 3 further optimizes the Christmas decoration device with optical fiber provided in Embodiment 1. Specifically, as shown in FIGS. 6 to 10, the light-emitting parts include a lamp cup 401, a lamp plate 404 is provided in the lamp cup 401, a plurality of second LED lights 403 are provided on the lamp plate 404. The plurality of second LED lights 403 are connected to the control circuit, and the plurality of second LED lights 403 are connected in series. Through the lamp plate 404, the plurality of second LED lights 403 can be connected together.

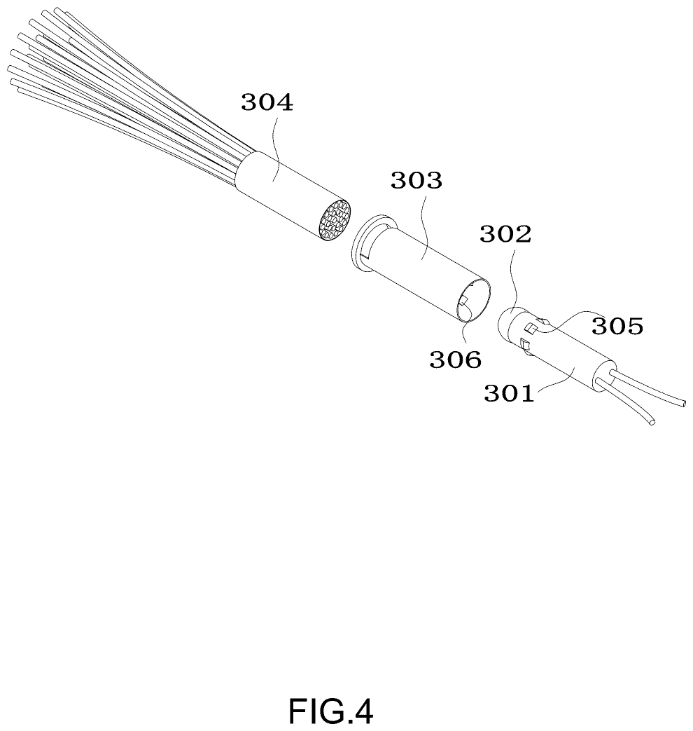

In an implementation, as shown in FIG. 4, the optical fiber part is a second optical fiber bundle 402, which is consisted of a plurality of optical fibers. The second optical fiber bundle 402 is provided on the plurality of second LED light 403, and the setting of the plurality of second LED lights 403 provides more light source choices. The user can adjust the brightness and color of light according to needs. An application of the second optical fiber bundle 402 renders light distribution more uniform, thereby improving the quality of the decorative effect. This design not only improves the flexibility of the decorative device, but also provides the user with more personalized decorative choices.

The first LED light 302 and the second LED light 403 are configured to display four colors: red, green, blue, and white, namely RGBW; in the RGBW technology is that white sub pixels were added to an original RGB three primary colors, thereby becoming a four-color pixel design. Under a new pixel layout, color consistency is achieved, and the transparency of liquid crystal display (LCD) panel is greatly improved. When displaying images with the same brightness, the power consumption is lower, while under the same power consumption, the brightness is significantly increased. Thus, visual hierarchy of the image is more distinct, and the image is more transparent.

The LED lights combined with optical fibers are used in the present application to enhance beauty of a Christmas tree.

Embodiment 4, a circuit control method for controlling a Christmas decoration device with optical fibers, including:
a first circuit interface port and a second circuit interface port being configured to be an input terminal, connect to an external power or a signal source, the first circuit interface port is configured to provide a main power input and conduct preliminary rectification and current limiting through a diode D1 and a resistor R1 to obtain voltage supply for the circuit; at the same time, a filtering and voltage regulator circuit is formed by a capacitor C1, a resistor R1, and a voltage stabilizing diode Z1 together so as to perform smooth processing on power supply and voltage to eliminate a potential impact of power fluctuation and noise on circuit performance, thereby ensuring a stable operation of a main control chip U1 and a radio frequency chip;
color and mode of a LED light is manually controlled through a button switch S1 by a user after the circuit is powered on normally, when the button switch S1 or a control button of a remote control 500 is pressed by the user, electrical signal is transmitted to the main control chip U1, the signal is analyzed by the main control chip U1 according to a preset program logic and a corresponding control instruction is generated; then the control instruction is transmitted to a drive circuit of the LED light through an output pin of the main control chip U1; a third circuit interface port is configured to be as one of output terminals, connect the drive circuit of LED light and transmit a control signal; driving current, frequency, and direction of the LED light are adjusted by the drive circuit of LED light according to an instruction after receiving it so as to change the color and mode of the LED light;
a radio frequency chip U2 and a radio frequency chip RF, configured to receive signal from the remote control 500 or other wireless devices; the signal is decoded by the radio frequency chip U2 and radio frequency chip RF and transmitted to the main control chip U1 when a valid wireless signal is received; a corresponding control logic according to the instruction in the wireless signal is executed by the main control chip U1 and the control signal is sent to the LED light through the third circuit interface port;
a first grounding terminal GND1, a second grounding terminal GND2, a third grounding terminal GND3, and a fourth grounding terminal GND4 provide a stable reference potential for the circuit, ensuring that electrical signal in the circuit can be transmitted and processed correctly; at the same time, an oscillation circuit of the radio frequency chip is formed by the capacitor C3 and capacitor C2, as well as the crystal oscillator circuit Y1, thereby providing the frequency reference for a stable transmission and reception of RF signal;
power supply and external control signal are received through the first circuit interface port and second circuit interface port, processed by the main control chip U1 and radio frequency chip RF, the control instruction is outputted by the third circuit interfaces port, the fourth circuit interface port and a fifth circuit interface port so as to control the color and mode of the LED light.
the oscillation circuit of the radio frequency chip is formed by the capacitor C3 and capacitor C2, together with the crystal oscillator circuit Y1. This oscillation circuit provides the stable frequency reference for the radio frequency chip, thereby ensuring an accurate transmission and reception of wireless signal.

In the present disclosure, unless otherwise specified and limited, terms “installation”, “connection to”, “connection with”, “fixation” and other terms should be broadly understood, for example, it can be a fixed connection, a detachable connection, or an integrated connection; it can be a mechanical connection, an electrical connection, or an intercommunication with each other; it can be a direct connection or indirect connection through an intermediate medium, it can be an internal connection of two components or the interaction relationship between two components, unless otherwise specified. For ordinary technical personnel in this field, a specific meaning of the terms in the present disclosure can be understood based on a specific circumstance.

Obviously, the embodiments described above are only a part of the embodiments of the present disclosure, not all of them. The preferred embodiments of the present disclosure are shown in the accompanying drawings, but they do not limit the scope of the present disclosure. The present disclosure can be implemented in many different forms, and conversely, a purpose of providing these embodiments is to provide a more thorough and comprehensive understanding of the disclosed content of the present disclosure. Although the present disclosure has been described in detail with reference to the embodiments, those skilled in the art can still modify the technical solutions recorded in the embodiments, or equivalently replace some of the technical features. Any equivalent structure made with the specification and drawings of the present disclosure, directly or indirectly applied in other related technical fields, is also within the protection scope of the present disclosure.

What is claimed is:

1. A Christmas decoration device with optical fibers, comprising a controller, wherein the controller is connected with a plurality of light-emitting components in series, the light-emitting components comprise light-emitting parts that are connected with the controller in series, each light-emitting part is connected to an optical fiber part, the optical fiber part is configured to transmit light emitted by the light-emitting parts, the controller comprises a control circuit, and the light-emitting parts realize color switching under a control of the control circuit.

2. The Christmas decoration device with optical fibers according to claim 1, wherein the control circuit comprises a first circuit interface port and a second circuit interface port, the first circuit interface port is connected to a diode D1, a resistor R1, and a third circuit interface port; the diode D1 is connected to the second circuit interface port, the resistor R1 is connected to a voltage stabilizing diode Z1 and a capacitor C1, both the capacitor C1 and the voltage stabilizing diode Z1 are connected to the second circuit interface port; a first grounding terminal GND1 is connected between the second circuit interface port, diode D1, and capacitor C1;
the control circuit further comprises a main control chip U1, a radio frequency chip U2, a radio frequency chip RF, the capacitor C1, the resistor R1, and the voltage stabilizing diode Z1; wherein a first pin of the main control chip U1, a first pin of the radio frequency chip U2 and a first pin of the radio frequency chip RF are connected;
a second pin of the main control chip U1 is connected to a fourth circuit interface port, an eighth pin of the main control chip U1 is connected to a button switch S1, the eighth pin of the main control chip U1 is further connected to the capacitor C1, the voltage stabilizing diode Z1, and the first grounding terminal GND1; the other end of the button switch S1 is connected to a fifth pin of the radio frequency chip U2.

3. The Christmas decoration device with optical fibers according to claim 2, wherein the diode D1 is further connected to a second grounding terminal GND2, the second grounding terminal GND2 is connected to a third grounding terminal GND3, and the third grounding terminal GND3 is connected to a fifth circuit interface port, a third pin of the radio frequency chip RF and a fourth pin of the radio frequency chip RF are both connected to the third grounding terminal GND3;
a seventh pin of the main control chip U1 is connected to a sixth pin of the radio frequency chip U2, the sixth pin of the main control chip U1 is connected to a seventh pin of the radio frequency chip U2, the eighth pin of the radio frequency chip U2 is connected to a fourth grounding terminal GND4, a third pin of the radio frequency chip U2 and a second pin of the radio frequency chip U2 are respectively connected with a capacitor C3 and a capacitor C2, both capacitor C3 and capacitor C2 are connected to the third grounding terminal GND3 and the fifth circuit interface port; a crystal oscillator circuit Y1 is connected in parallel between the third pin of the radio frequency chip U2 and the second pin of the radio frequency chip U2.

4. The Christmas decoration device with optical fibers according to claim 3, wherein the control circuit is further connected to a remote control, which is provided with a control motherboard, and a communication module and a plurality of control buttons are connected to the control motherboard.

5. The Christmas decoration device with optical fibers according to claim 4, wherein the light-emitting parts comprise a lamp housing, an end of the lamp housing is connected to a first LED light, and the first LED light is connected to the control circuit; an outer surface of the lamp housing is sleeved with a connection tube, a retaining ring is fixedly provided in the connection tube, and the retaining ring is in contact with the first LED light.

6. The Christmas decoration device with optical fibers according to claim 5, wherein the outer surface of the lamp housing is fixedly connected with a plurality of first protrusions, an inner wall of the connection tube is fixedly connected with a plurality of second protrusions; the second protrusions and the first protrusions are interlocked so as to limit the lamp housing.

7. The Christmas decoration device with optical fibers according to claim 6, wherein the optical fiber part is a first optical fiber bundle, which is consisted of a plurality of optical fibers, an end of the first optical fiber bundle is connected to the connection tube in an insertion manner.

8. The Christmas decoration device with optical fibers according to claim 4, wherein the light-emitting parts comprise a lamp cup, wherein a lamp plate is provided in the lamp cup, and a plurality of second LED lights are provided on the lamp plate, the second LED lights are connected to the control circuit.

9. The Christmas decoration device with optical fibers according to claim 8, wherein the optical fiber part is a second optical fiber bundle, which is consisted of a plurality of optical fibers, and the second optical fiber bundle is provided on the second LED light.

10. A circuit control method for controlling the Christmas decoration device with optical fibers according to claim 6, the circuit control method comprises:
a first circuit interface port and a second circuit interface port being configured to be an input terminal, connect to an external power supply or a signal source, the first circuit interface port is configured to provide a main power supply input and conduct preliminary rectification and current limiting through a diode D1 and a resistor R1 to obtain voltage supply for the circuit; a filtering and voltage regulator circuit is formed by a capacitor C1, a resistor R1, and a voltage stabilizing diode Z1 together so as to perform a smooth processing on power supply and voltage;
color and mode of a LED light is manually controlled through a button switch S1 by a user after the circuit is powered on normally, when the button switch S1 or a control button of a remote control is pressed by the user, electrical signal is transmitted to a main control chip U1, the signal is analyzed by the main control chip U1 according to a preset program logic and a corresponding control instruction is generated; then the control instruction is transmitted to a drive circuit of the LED light through an output pin of the main control chip U1; a third circuit interface port is configured to be as one of output terminals, connect the drive circuit of LED light and transmit a control signal; driving current, frequency, and direction of the LED light are adjusted by the drive circuit of LED light according to the instruction after receiving it so as to change the color and mode of the LED light;
a radio frequency chip U2 and a radio frequency chip RF, configured to receive signal from the remote control or other wireless devices; the signal is decoded by the radio frequency chip U2 and radio frequency chip RF and transmitted to the main control chip U1 when a valid wireless signal is received; a corresponding control logic according to the instruction in the wireless signal is executed by the main control chip U1 and the control signal is sent to the LED light through the third circuit interface port;
power supply and external control signal are received through the first circuit interface port and second circuit interface port, processed by the main control chip U1 and radio frequency chip RF, the control instruction is outputted by the third circuit interfaces port, a fourth circuit interface port and a fifth circuit interface port so as to control the color and mode of the LED light.
